(19) United States
(12) Patent Application Publication
(10) Pub. No.: US 2026/0169992 A1
(43) Pub. Date: Jun. 18, 2026

(54) USING MACHINE-LEARNING MODEL FOR PERSONALIZED REARRANGEMENT OF ITEMS FROM A PHYSICAL DOCUMENT IN A USER INTERFACE

(71) Applicant: Maplebear Inc., San Francisco, CA (US)

(72) Inventors: Varun Garg, Issaquah, WA (US); Bryan Mierdel, East Gwillimbury (CA); Colin Banigan, San Francisco, CA (US); Preeti Chadha, Poughkeepsie, NY (US); Yunzhi Ye, Bothell, WA (US)

(21) Appl. No.: 18/979,392

(22) Filed: Dec. 12, 2024

(51) Int. Cl. G06F 16/2457; G06F 16/248; G06F 16/25; G06F 16/28; G06F 16/93; G06N 20/00

(52) U.S. Cl. CPC G06F 16/24578; G06F 16/248; G06F 16/258; G06F 16/285; G06F 16/93; G06N 20/00

(57) ABSTRACT

An online system uses a trained machine-learning model for personalized rearrangement of items from a physical document in a user interface. The online system obtains an electronic version of the physical document including metadata for each item in the physical document. The online system applies the machine-learning model to the metadata, information about each item, and information about a user to generate an item conversion score for each item that is indicative of the likelihood of the user converting on each item. The online system ranks, using the item conversion score for each item, items from the physical document. Based on the ranking, the online system generates a user interface signal including information about a rearrangement of each item. The user interface signal causes a device associated with the user to display a user interface with each item placed at the user interface in accordance with the rearrangement.

### BACKGROUND

An online system allows their users to browse and acquire items by placing online orders, where the items are provided by sources (e.g., retailers) associated with the online system. The sources print or otherwise publish (e.g., in an electronic form) their promotional documents (e.g., flyers) on a regular basis (e.g., weekly, monthly, etc.) to inform their customers about upcoming promotions, discounts, special sales events, launching new products, etc. However, these printed promotional documents are static, and since the promotional documents are printed for all customers, content of the promotional documents cannot be personalized for a specific user of the online system. At best, promotional documents are personalized by a zip code or geographic region in which these promotional documents are distributed.

Therefore, there is a technical problem of how to personalize a promotional document printed or otherwise published by a source associated with the online system for a specific viewing user of the online system.

### SUMMARY

Embodiments of the present disclosure are directed to using a trained machine-learning model of an online system for personalized rearrangement of items from a document (e.g., printed physical document or electronic version of the printed physical document) in a user interface of the online system.

In accordance with one or more aspects of the disclosure, the online system obtains an electronic version of a physical document including metadata for each item of a plurality of items in the physical document. The online system accesses an item conversion prediction machine-learning model of the online system, wherein the item conversion prediction machine-learning model is trained to predict a likelihood of a user of the online system converting on each item of the plurality of items. The online system generates, by applying the item conversion prediction machine-learning model to the metadata, information about each item of the plurality of items, and information about the user, an item conversion score for each item of the plurality of items that is indicative of the likelihood of the user converting on each item of the plurality of items. The online system ranks, based at least in part on the item conversion score for each item, the plurality of items to generate a ranked plurality of items. The online system generates, using the ranked plurality of items, a first user interface signal including information about a rearrangement of each item of the plurality of items. The online system sends, via a network, the first user interface signal to a device associated with the user, wherein the sending the first user interface signal causes the device associated with the user to display a user interface with each item of the plurality of items placed at the user interface in accordance with the rearrangement.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example architectural flow diagram of using trained machine-learning models of an online system for personalized rearrangement of items from a physical document in a user interface of the online system, in accordance with one or more embodiments.

FIG. 4 is a flowchart for a method of using a trained machine-learning model of an online system for personalized rearrangement of items from a physical document in a user interface of the online system, in accordance with one or more embodiments.

### DETAILED DESCRIPTION

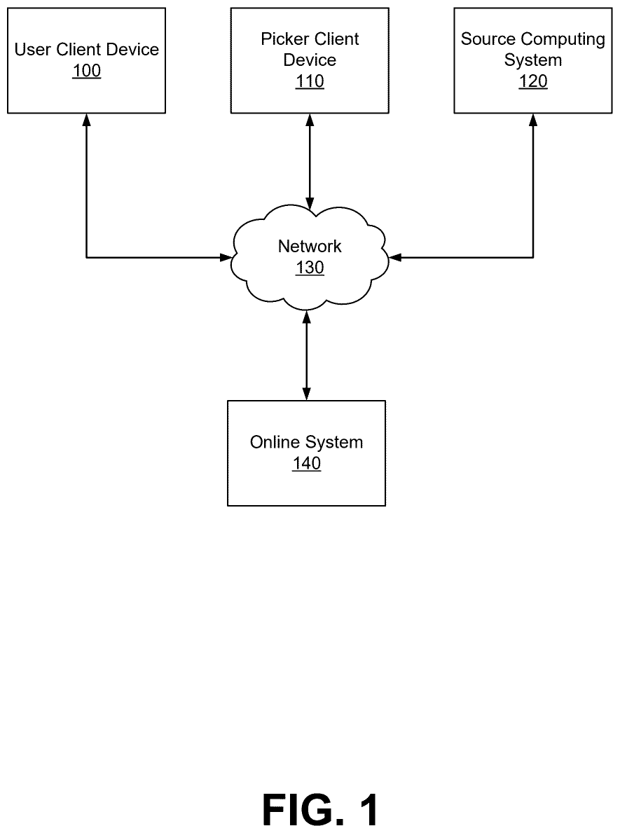

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered.

Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker (i.e., fulfillment agent, servicing agent, or agent) that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a source location. The user's order may specify which groceries they want to be delivered from the source location and the quantities of each of the groceries. The user client device 100 transmits the user's order to the online system 140 and the online system 140 selects a picker to travel to the source location to collect the groceries ordered by the user. The online system transmits an offer to the picker for the picker to service the order in exchange for consideration and, if the picker accepts the offer, the picker collects the groceries from the source location. Once the picker has collected the groceries ordered by the user, the picker delivers the groceries to a location transmitted to the picker client device 110 by the online system 140.

The online system 140 may ingest documents (e.g., promotional documents or flyers) and extract from the ingested documents information about the items listed in the documents. A document may be a physical document printed by a source (e.g., retailer) associated with the online system 140, or may be a digital document provided by the source in an electronic format. The online system 140 may group the items in each document by category, e.g., using a taxonomy maintained by the online system 140. The online system 140 may rank the items extracted from the document using a trained conversion (or engagement) prediction machine-learning model. The online system 140 may also rank the categories of items extracted from the document using another trained conversion (or engagement) prediction machine-learning model. Finally, the online system 140 may generate electronic pages based on each document, where each page rearranges the document by category according to the rankings.

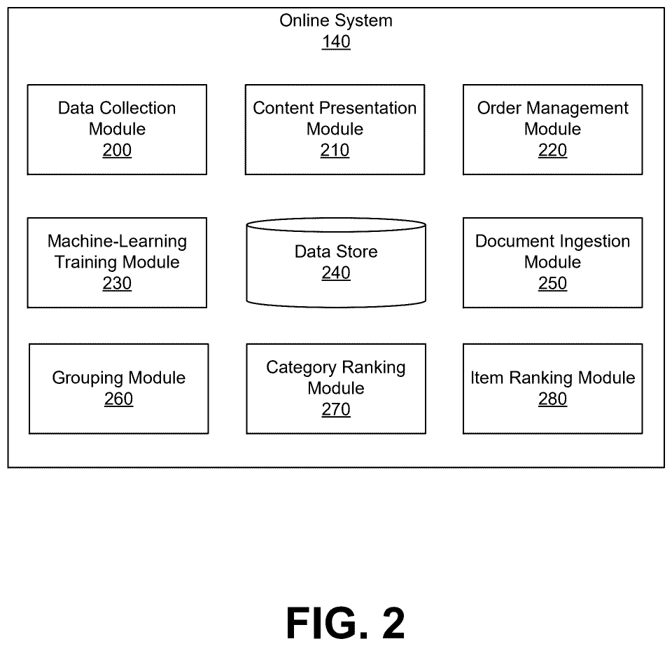

Hence, the online system 140 presented herein ingests a physical document (e.g., promotional document or flyer), and rearranges the items extracted from the document in a way that optimizes for engagement of the items by a viewing user of the online system 140. The optimization uses trained machine-learning models that are personalized for the viewing user. In this manner, the online system 140 generates, in a digital format, content of ingested documents (e.g., flyers) that is personalized for each user of the online system 140. The online system 140 may deploy the trained machine-learning models to rank categories of items and items within each category based on user's features, such as user's purchase history and user's interactions with sources and items. The personalized ranking of categories of items and items within each category makes the content of the document appealing to the user and increases the likelihood of a user's conversion on items in the document. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a document ingestion module 250, a grouping module 260, a category ranking module 270, and an item ranking module 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The document ingestion module 250 may ingest data associated with a document (e.g., promotional document or flyer). In one or more embodiments, the document ingestion module 250 ingests the document data through a recurring job that scans the physical document. In one or more other embodiments, the document ingestion module 250 receives an electronic version of the physical document. The document (e.g., electronic version of the physical document) may include metadata with information about identities of items in the document, information about promotions (e.g., start dates/end dates of promotions), information about item prices, document thumbnail, etc. Alternatively, the document ingestion module 250 may use optical character recognition (OCR) and/or computer vision to extract the same information from the document.

The grouping module 260 may receive the identities of the items in the document from the document ingestion module 250, and then group the items into categories (i.e., groups, clusters, or aisles) using the received information about item identities. In one or more embodiments, the grouping module 260 groups the items from the document by taxonomy of the items, such as using the hierarchical item taxonomy maintained by the online system 140 in an item catalog database (e.g., stored at the data store 240). In this manner, the grouping module 260 may group assortments of the document dynamically based on the taxonomy of items.

In one or more other embodiments, the grouping module 260 groups the items from the document into categories (i.e., groups, clusters, or aisles) by using embeddings of the items and by applying the nearest neighbor algorithm to the item embeddings. An embedding of an item may include an indication about past groupings (or classification) of that item with other items from the document. The grouping module 260 may generate an embedding vector for each item in the document. To achieve this, the grouping module 260 may retrieve, from an item catalog database and/or order catalog database (e.g., stored at the data store 240), information about past orders placed at the online system 140 including information about past groupings of items. The grouping module 260 may then include, using the retrieved information, an indication about a grouping of each item in the document with a corresponding other item in the document into a corresponding dimension of the embedding vector. For example, the value of 0 may be included into a corresponding dimension of the embedding vector if an item in the document was not grouped in the past with a corresponding other item in the document. Otherwise, the value of 1 may be included into a corresponding dimension of the embedding vector if the item in the document was grouped in the past with a corresponding other item in the document.

The grouping module 260 may generate the embeddings of the items in the document using information about past groupings of the items from users'historical orders. As such, the embeddings for the items are vectors in a high-dimensional latent space, where the individual dimension in the latent space have no meaning, but the relative position of the embeddings have meaning-specifically, the distance between two vectors indicates how likely the items are to be grouped into a same category.

Note that one important purpose of utilizing embeddings is a dimensional reduction. If there are a very large number of items, N, then information about the past groupings of the items can be stored in an N×N matrix, which tends to be a relatively sparse matrix. Accordingly, as the data scales with the factor of N2, it makes working with non-embedding information impossible on conventional real-world computing systems. However, by converting the item grouping information into a single high-dimensional embedding vector for each item, the embedding information scales linearly with N (e.g., if the number of items is doubled, the number of embeddings is only twice larger). This dimensional reduction is a solution to a technical problem of performing operations with very large datasets, such as the grouping of items from a very large catalog of items stored in the data store 240.

The category ranking module 270 may run a category conversion prediction model (e.g., machine-learning model) to rank categories of items generated by the grouping module 260. The category ranking module 270 may feed the categories of items generated by the grouping module 260 into the category conversion prediction model so that the category conversion prediction model generates a personalized ranked list of item categories. The category conversion prediction model may take into account various features for a current user, such as user's interactions with categories of items and user's purchase history. The category conversion prediction model may be implemented as a deep neural network (DNN) machine-learning model.

The category ranking module 270 may access the category conversion prediction model that is trained to predict a likelihood of a user of the online system 140 converting on an item in a given category of items. The category ranking module 270 may deploy the category conversion prediction model to run a machine-learning algorithm to input signals to generate a category conversion score that is indicative of the likelihood of the user converting on the item in the given category of items. The category conversion score may be a value between 0 and 1, where a higher value of the category conversion score may indicate a higher likelihood of the user converting on the item in the given category of items, and a lower value of the category conversion score may indicate a lower likelihood of the user converting on the item in the given category of items. A set of parameters for the category conversion prediction model may be stored at one or more non-transitory computer-readable media of the category ranking module 270. Alternatively, the set of parameters for the category conversion prediction model may be stored at one or more non-transitory computer-readable media of the data store 240.

Hence, the category conversion prediction model may be trained to generate a category conversion score that represents a predicted rate for a user's conversion on a given category of items. Alternatively, the category conversion prediction model may be trained to generate a category conversion score by aggregating individual item conversion scores for items in a category of items generated by the grouping module 260, where each item conversion score represents a likelihood of a user converting on a corresponding item from the category of items. Alternatively, the category conversion prediction model may be trained to predict some other metric in relation to a given category of items generated by the grouping module 260, such as predicting a gross merchandise value (GMV) for the given category of items, i.e., predicting a value of a user's conversion on the given category of items.

In one or more embodiments, the category ranking module 270 uses category conversion scores for all categories of items generated by the grouping module 260 to rank the categories of items such that the highest ranked category has a highest conversion score among all the categories, the second highest ranked category has a second highest conversion score among all the categories, and so on. The category ranking module 270 may generate a category ranking signal with information about the ranking of the categories. The content presentation module 210 may use the category ranking signal to generate a user interface signal that causes the user client device 100 to display a user interface with the user's preferred ranking of categories, i.e., a category of items that is display at the top of a display page of the user interface is a category for which there is a highest likelihood of user's conversion. Then, the user may utilize the user interface to navigate across tabs of the ranked categories, as well as within a tab for each category to view all the items from the document (e.g., flyer). Additionally, the category ranking module 270 may provide the category ranking signal to the item ranking module 280, which may be then used for personalized ranking of individual items within each category of items.

In providing the input signals to the category conversion prediction model, the category ranking module 270 may provide item data including information about to which category of a set of categories generated by the grouping module 260 each item belongs, an identifier of each item, an embedding for each item, a popularity score for each item (e.g., historic overall conversion rate for that item), a buy-it-again (BIA) score for each item (e.g., historic conversion rate for that item when presented as a BIA item), promotional information for each item, some other item related features, or some combination thereof. The category ranking module 270 may obtain the item identifiers and the item embeddings from the grouping module 260. The category ranking module 270 may retrieve the popularity score and the BIA score from an item catalog database (e.g., stored at the data store 240). Additionally, the category ranking module 270 may receive the item promotional information from the source computing system 120 via the network 130.

In providing the input signals to the category conversion prediction model, the category ranking module 270 may further provide user data including an identifier of a user, an embedding for the user, information about the user's tenure at the online system 140, information about the user's order history, some other user related features, or some combination thereof. The embedding for the user may be an embedding vector where each vector dimension includes an indication (e.g., value of 0 or 1) about whether the user converted on a corresponding category of items. The category ranking module 270 may retrieve the user's identifier, information about the user's tenure, and information about the user's order history from a user catalog database (e.g., stored at the data store 240). Additionally, the category ranking module 270 may derive the embedding for the user using user's conversion data retrieved from the user catalog database.

In providing the input signals to the category conversion prediction model, the category ranking module 270 may further provide contextual data including information about the user's online platform (e.g., iOS, Android, or Internet), information about the user's local time, information about the user's current cart (e.g., information about what items are already in the user's cart), some other contextual features, or some combination thereof. The category ranking module 270 may receive the contextual data in real time from the user client device 100 via the network 130.

The machine-learning training module 230 may perform initial training of the category conversion prediction model using training data. The machine-learning training module 230 may generate labels for the training data, where each label includes an indication of users'conversions on each category of item from a collection of categories (e.g., historical conversion rate for each item category) and an indication of one or more ranking features for each category of items from the collection of categories. The machine-learning training module 230 may train the category conversion prediction model using the training data to generate initial values for the set of parameters of the category conversion prediction model.

The machine-learning training module 230 may collect feedback data with information about a user's engagement with each category of items displayed as a ranked category at the user interface of the user client device 100. The information about the user's engagement may include an indication of the user's conversion of one or more items from a given category of items (e.g., information on whether the user added the one or more items from the given category to the cart or otherwise ordered the one or more items), information about the user's viewing a category of items without converting on any items from the category, or some other information about the user's engagement with each category of items displayed in a ranked manner at the user interface. The information about the user's engagement may be recorded at the user client device 100 and communicated, via the network 130, to the online system 140 and the machine-learning training module 230 as the feedback data. The machine-learning training module 230 may then re-train the category conversion prediction model by updating the set of parameters of the category conversion prediction model using the feedback data.

The item ranking module 280 may rank items, such as items from each category of items generated by the grouping module. The item ranking module 280 may feed information about the items in a given category of items to an item conversion prediction model (e.g., machine-learning model) to generate a personalized ranked list of items within that category of items. Alternatively, the item ranking module 280 may feed to the item conversion prediction model information about all the items from the document irrespective of to which category each item belongs in order to generate an overall personalized ranked list of items from the document. The item conversion prediction model may take into account various features for a current user, such as user's interactions with items and user's purchase history. The item conversion prediction model may be implemented as a DNN machine-learning model.

The item ranking module 280 may access the item conversion prediction model that is trained to predict a likelihood of a user of the online system 140 converting on a given item.

The item ranking module 280 may deploy the item conversion prediction model to run a machine-learning algorithm to input signals to generate an item conversion score that is indicative of the likelihood of the user converting on the given item. The item conversion score may be a value between 0 and 1, where a higher value of the item conversion score may indicate a higher likelihood of the user converting on the given item, and a lower value of the item conversion score may indicate a lower likelihood of the user converting on the given item. A set of parameters for the item conversion prediction model may be stored at one or more non-transitory computer-readable media of the item ranking module 280. Alternatively, the set of parameters for the item conversion prediction model may be stored at one or more non-transitory computer-readable media of the data store 240.

Hence, the item conversion prediction model may be trained to generate an item conversion score that represents a predicted rate for a user's conversion on a given item. Alternatively, the item conversion prediction model may be trained to predict some other metric in relation to a given item, such as predicting a GMV for the given item, i.e., predicting a value of a user's conversion on the given item.

In one or more embodiments, the item ranking module 280 uses item conversion scores for all items in a category of items or for all items from the document to rank the items within each category or among all the items from the document such that the highest ranked item (from a given category or among all the items from the document) has a highest conversion score among all items with the given category or among all the items from the document, the second highest ranked item has a second highest conversion score among all items with the given category or among all the items from the document, etc. The item ranking module 280 may generate an item ranking signal with information about the ranking of items. The content presentation module 210 may use the item ranking signal to generate a user interface signal that causes the user client device 100 to display a user interface with the user's preferred ranking of items, either within each category of items or among all the items from the document. Thus, in one or more embodiments, the user interface may display the ranked categories of items (e.g., as generated by the category ranking module 270), and also the ranked items within each ranked category of items (e.g., as generated by the item ranking module 280). In such cases, the highest ranked category may be displayed on top of a display page of the user interface, and when the user selects the highest ranked category for viewing, a display page of the user interface is updated to display the highest ranked item within the highest ranked category on top of the updated display page. In one or more other embodiments, the user interface may display the overall ranked items irrespective of item categories (e.g., as generated by the item ranking module 280). In such cases, the highest overall ranked item may be displayed on top of a display page of the user interface, the second highest overall ranked item may be displayed on the display page of the user interface immediately below the highest overall ranked item, and so on.

In providing the input signals to the item conversion prediction model, the item ranking module 280 may provide item data including information about which category of a set of categories generated by the grouping module 260 each item belongs to, an identifier of each item, an embedding for each item, a popularity score for each item (e.g., historic overall conversion rate for that item), a BIA score for each item (e.g., historic conversion rate for that item when presented as a BIA item), promotional information for each item, some other item related features, or some combination thereof. The item ranking module 280 may obtain the item identifiers and the item embeddings from the grouping module 260. The item ranking module 280 may retrieve the popularity score and BIA score from an item catalog database and/or order catalog database (e.g., stored at the data store 240). Additionally, the item ranking module 280 may receive the item promotional information from the source computing system 120 via the network 130.

In providing the input signals to the item conversion prediction model, the item ranking module 280 may further provide user data including an identifier of a user, an embedding for the user, information about the user's tenure at the online system 140, information about the user's order history, some other user related features, or some combination thereof. The embedding for the user may be an embedding vector where each vector dimension includes an indication (e.g., value of 0 or 1) about whether the user converted in the past on a respective item from a category of items or from a set of items from the document. The item ranking module 280 may retrieve the user's identifier, information about the user's tenure, and information about the user's order history from a user catalog database (e.g., stored at the data store 240). Additionally, the item ranking module 280 may derive the embedding for the user using user's conversion data retrieved from the user catalog database.

In providing the input signals to the item conversion prediction model, the item ranking module 280 may further provide contextual data including information about the user's online platform (e.g., iOS, Android, or Internet), information about the user's local time, information about the user's current cart (e.g., information about what items are already in the user's cart), some other contextual features, or some combination thereof. The item ranking module 280 may receive the contextual data in real time from the user client device 100 via the network 130.

The machine-learning training module 230 may perform initial training of the item conversion prediction model using training data. The machine-learning training module 230 may generate labels for the training data, where each label includes an indication of users'conversions on each item from a collection of items (e.g., historical conversion rate for each item) and an indication of one or more ranking features for each item from the collection of items. The machine-learning training module 230 may train the item conversion prediction model using the training data to generate initial values for the set of parameters of the item conversion prediction model.

The machine-learning training module 230 may collect feedback data with information about a user's engagement with each item displayed as a ranked item at the user interface of the user client device 100. The information about the user's engagement may include an indication of the user's conversion of each ranked item (e.g., information on whether the user added that ranked items to the cart or otherwise ordered that ranked item), information about the user's viewing product details for a ranked item without converting on the ranked item, or some other information about the user's engagement with each ranked item displayed at the user interface. The information about the user's engagement may be recorded at the user client device 100 and communicated, via the network 130, to the online system 140 and the machine-learning training module 230 as the feedback data. The machine-learning training module 230 may then re-train the item conversion prediction model by updating the set of parameters of the item conversion prediction model using the feedback data.

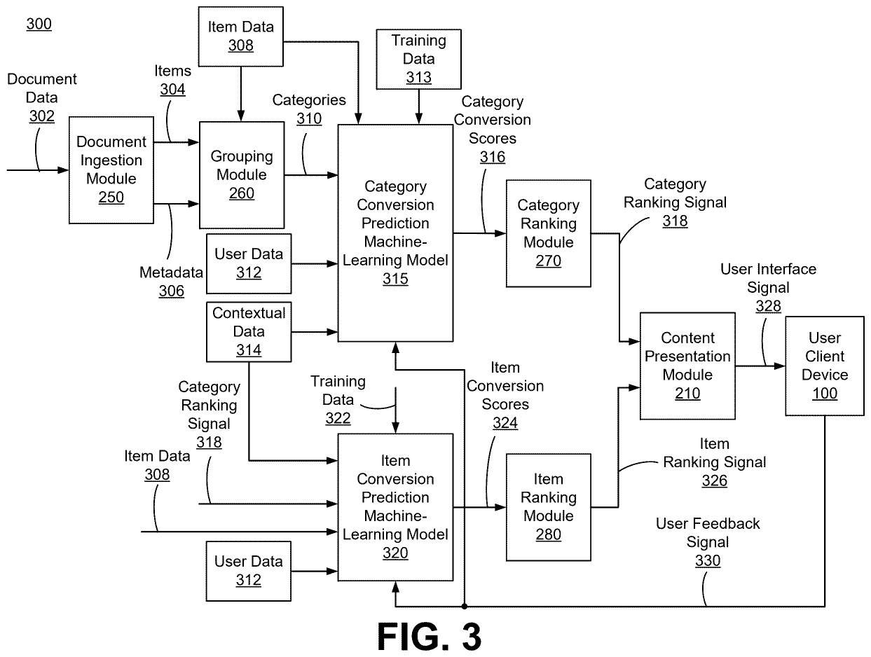

FIG. 3 illustrates an example architectural flow diagram 300 of using trained machine-learning models of the online system 140 for personalized rearrangement of items from a document (e.g., physical document or electronic version of the physical document) in a user interface of the online system 140, in accordance with one or more embodiments. Document data 302 may be received at the document ingestion module 250. The document data 302 may represent an electronic version of a physical document (e.g., promotional document or flyer). The document data 302 may be obtained by, e.g., applying an OCR and/or computer vision to the physical document. Alternatively, the document data 302 may be directly received from, e.g., the source computing system 120 via the network 130. The document ingestion module 250 may process the document data 302 to retrieve items 304 in the physical document and/or metadata 306 for each item, such as an identity of each item, cost of each item, promotional information for each item, etc. The document ingestion module 250 may pass information about the items 304 and their metadata 306 to the grouping module 260.

The grouping module 260 may group, using the metadata 306 and item data 308 (e.g., retrieved from the data store 240), the items 304 into categories 310. In one or more embodiments, the item data 308 include information about a hierarchical classification (i.e., taxonomy) of each item 304. In one or more other embodiments, the item data 308 include embeddings for the items 304, where an embedding for each item 304 includes an indication of a past classification (or grouping) of each item 304 with other items 304. In such cases, the grouping module 260 may apply the nearest neighbor algorithm to the embeddings for the items 304 to group the items 304 into the categories 310. The grouping module 260 may pass information about the categories 310 to a category conversion prediction machine-learning model 315.

Prior to running a machine-learning algorithm of the category conversion prediction machine-learning model 315, the online system 140 may perform (e.g., via the machine-learning training module 230) initial training of the category conversion prediction machine-learning model 315 using training data 313 to generate initial values for a set of parameters of the category conversion prediction machine-learning model 315. The machine-learning training module 230 may generate labels for the training data 313, where each label includes an indication of a conversion rate of each category from a collection of categories over a defined time period (e.g., month, six months, year, etc.) and another indication of a ranking feature for each category from the collection of categories. After the training process is completed, the online system 140 may provide a set of inputs to the category conversion prediction machine-learning model 315 (e.g., via the category ranking module 270), such as the item data 308, user data 312, and contextual data 314. Some additional inputs not shown in FIG. 3 may be further provided to the category conversion prediction machine-learning model 315.

In providing the item data 308 to the category conversion prediction machine-learning model 315, the category ranking module 270 may provide information about to which category 310 each item belongs, an identifier of each item 304, an embedding for each item 304, a popularity score for each item 304, a BIA score for each item 304, promotional information for each item, some other item related features, or some combination thereof. Some of the item data 308 may be part of the metadata 306, and some of the item data 308 may be derived from data retrieved from the item catalog database.

In providing the user data 312 to the category conversion prediction machine-learning model 315, the category ranking module 270 may provide an identifier of a user, an embedding for the user, information about the user's tenure at the online system 140, information about the user's order history, some other user related features, or some combination thereof. The category ranking module 270 may retrieve the user data 312 from a user catalog database (e.g., stored at the data store 240).

In providing the contextual data 314 to the category conversion prediction machine-learning model 315, the category ranking module 270 may provide information about the user's online platform (e.g., iOS, Android, or Internet), information about the user's local time, information about the user's current cart (e.g., information about what items are already in the user's cart), some other contextual features, or some combination thereof. The category ranking module 270 may receive the contextual data 314 in real time from the user client device 100 via the network 130.

The category conversion prediction machine-learning model 315 may apply the machine-learning algorithm to the item data 308, information about content of the categories 310 (e.g., information about what items are in each category 310), the user data 312, and/or the contextual data 314 to generate a category conversion score 316 for each category 310 that is indicative of a likelihood of the user converting on one or more items in each category 310. The category conversion prediction machine-learning model 315 may pass category conversion scores 316 for the categories 310 to the category ranking module 270.

The category ranking module 270 may rank the categories 310 using the category conversion scores 316 to generate a ranked set of categories, where the highest ranked category has the highest category conversion score 316, the second highest ranked category has the second highest category conversion score 316, etc. The category ranking module 270 may pass a category ranking signal 318 with information about the ranked set of categories to the content presentation module 210. Additionally, the category ranking module 270 may pass the category ranking signal 318 with information about the ranked set of categories to an item conversion prediction machine-learning model 320.

Prior to running a machine-learning algorithm of the item conversion prediction machine-learning model 320, the online system 140 may perform (e.g., via the machine-learning training module 230) initial training of the item conversion prediction machine-learning model 320 using training data 322 to generate initial values for a set of parameters of the item conversion prediction machine-learning model 320. The machine-learning training module 230 may generate labels for the training data 322, where each label includes an indication of a conversion rate of each item from a collection of items over a defined time period (e.g., month, six months, year, etc.) and another indication of a ranking feature for each item from the collection of categories. After the training process is completed, the online system 140 may provide a set of inputs to the item conversion prediction machine-learning model 320 (e.g., via the item ranking module 280), such as the item data 308, the user data 312, the contextual data 314, and the category ranking signal 318. Some additional inputs not shown in FIG. 3 may be further provided to the item conversion prediction machine-learning model 320.

The item conversion prediction machine-learning model 320 may apply the machine-learning algorithm to the item data 308, the user data 312, the contextual data 314, and/or the category ranking signal 318 to generate an item conversion score 324 for each item in each category 310 that is indicative of a likelihood of the user converting on that item. The item conversion prediction machine-learning model 320 may pass item conversion scores 324 for all items in each category 310 to the item ranking module 280.

The item ranking module 280 may rank the items in each category 310 using the item conversion scores 324 to generate a ranked set of items for each category 310, where the highest ranked item in each category 310 has the highest item conversion score 324 among all items in that category 310, the second highest ranked item has the second highest item conversion score 324 among all items in that category 310, and so on. The item ranking module 280 may pass an item ranking signal 326 with information about the ranked set of items in each category 310 to the content presentation module 210.

The content presentation module 210 may utilize the category ranking signal 318 and/or the item ranking signal 326 to generate a user interface signal 328. The content presentation module 210 may send, via the network 130, the user interface signal 328 to the user client device 100. When the user interface signal 328 is generated using the category ranking signal 318, the user interface signal 328 may cause the user client device 100 to display a user interface with the user's preferred ranking of categories. In such cases, a category of items that is displayed at the top of a display page of the user interface is a category having the highest category conversion score 316 (i.e., the highest likelihood of user's conversion on an item in that category); a category of items that is displayed at the user interface immediately after the top ranked category may a category with the second highest category conversion score 316 (i.e., the second highest likelihood of user's conversion on an item in that category), and so on. Thus, the categories 310 are rearranged at the user interface in accordance with the information about the ranked set of categories in the category ranking signal 318, i.e., in accordance with the likelihood of user's conversion on each category.

The user may utilize one or more user interface elements to browse at the user interface through each category of items. When the user selects a specific category of items, the user interface is updated based on the item ranking signal 326 that includes the information about the ranked set of items in each category 310. As the user interface signal 328 is generated using the item ranking signal 326, the user interface signal 328 may cause the user client device 100 to display the user interface with the user's preferred ranking of items within each category 310. In such cases, an item that is displayed at the top of a display page of the user interface is an item having the highest item conversion score 324 among all items in that category 310 (i.e., the highest likelihood of user's conversion); an item that is displayed at the user interface immediately after the top ranked item may an item with the second highest item conversion score 324 among all items in that category 310 (i.e., the second highest likelihood of user's conversion), and so on. Thus, items within each category 310 are rearranged at the user interface in accordance with the information about the ranked set of items in each category 310, i.e., in accordance with the likelihood of user's conversion on each item in a specific category of items.

The user client device 100 may record feedback data with an indication of whether the user converted on any category 310 displayed at the user interface. Additionally, the user client device 100 may record feedback data with an indication of whether the user converted on any item displayed at the user interface. The user client device 100 may communicate, via the network 130, the recorded feedback data back to the online system (e.g., the machine-learning training module 230) as a user feedback signal 330. The machine-learning training module 230 may utilize the user feedback signal 330 to re-train the category conversion prediction machine-learning model 315 and the item conversion prediction machine-learning model 320. By utilizing user feedback signals 330 with conversion information for various users over time, the machine-learning training module 230 may continuously update the set of parameters of the category conversion prediction machine-learning model 315 and the set of parameters of the item conversion prediction machine-learning model 320, and continuously improve the machine-learning algorithm of the category conversion prediction machine-learning model 315 and the machine-learning algorithm of the item conversion prediction machine-learning model 320.

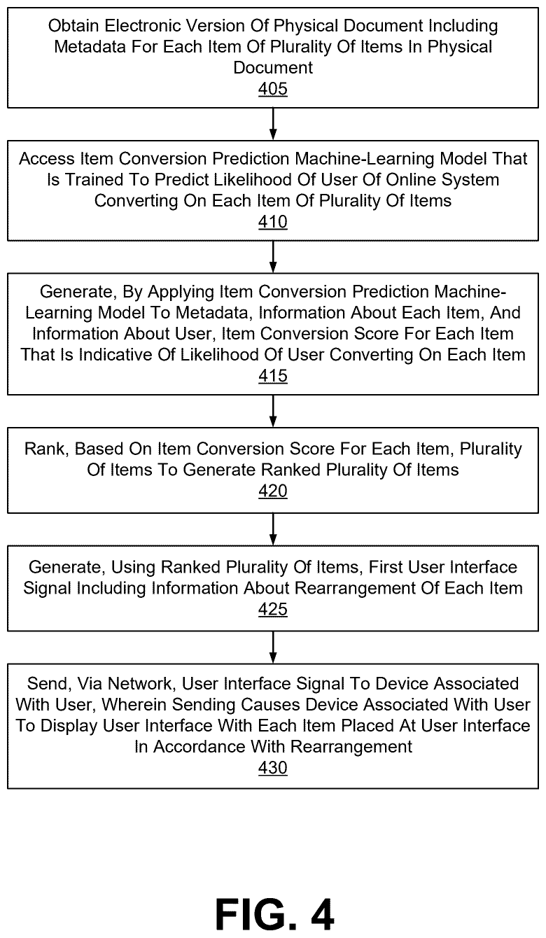

FIG. 4 is a flowchart for a method of using a trained machine-learning model of an online system for personalized rearrangement of items from a physical document in a user interface of the online system 140, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 obtains 405 (e.g., via the document ingestion module 250) an electronic version of a physical document (e.g., promotional document or flyer) including metadata for each item (e.g., an identity of each item, cost of each item, etc.) of a plurality of items in the physical document. The online system 140 may apply (e.g., via the document ingestion module 250) at least one of an optical character recognition or a computer vision to the physical document to obtain the electronic version of the physical document including the metadata.

The online system 140 accesses 410 an item conversion prediction machine-learning model of the online system 140 (e.g., via the item ranking module 280), wherein the item conversion prediction machine-learning model is trained to predict a likelihood of a user of the online system 140 converting on each item of the plurality of items. The online system 140 generates 415, by applying the item conversion prediction machine-learning model (e.g., via the item ranking module 280) to the metadata, information about each item of the plurality of items, and information about the user, an item conversion score for each item of the plurality of items that is indicative of the likelihood of the user converting on each item of the plurality of items.

The online system 140 may retrieve (e.g., via the category ranking module 270 or the item ranking module 280), from a database of the online system 140 (e.g., the data store 240), the information about the user including at least one of an identifier of the user, information about past conversions conducted by the user, or an embedding for the user, the embedding for the user including indications on whether the user converted on each of the plurality of items. The online system 140 may receive (e.g., at the item ranking module 280), from a device associated with the user (e.g., the user client device 100) and via a network (e.g., the network 130), contextual data including at least one of information about an operating system running on the device associated with the user, information about a local time of the user, or information about one or more items the user converted during a current online session. The online system 140 may apply the item conversion prediction machine-learning model (e.g., via the item ranking module 280) further to the contextual data to generate the item conversion score for each item of the plurality of items.

The online system 140 ranks 420 (e.g., via the item ranking module 280), based at least in part on the item conversion score for each item, the plurality of items to generate a ranked plurality of items. The online system 140 generates 425 (e.g., via the content presentation module 210), using the ranked plurality of items, a first user interface signal including information about a rearrangement of each item of the plurality of items. The online system 140 sends 430 (e.g., via the content presentation module 210), via a network (e.g., via the network 130), the first user interface signal to a device associated with the user (e.g., the user client device 100), wherein the sending the first user interface signal causes the device associated with the user to display a user interface with each item of the plurality of items placed at the user interface in accordance with the rearrangement.

The online system 140 may generate (e.g., via the machine-learning training module 230) a plurality of labels for training data, each label of the plurality of labels including a first indication of a conversion rate of each item from a collection of items over a defined time period and a second indication of a ranking feature for each item from the collection of items. The online system 140 may train (e.g., via the machine-learning training module 230), using the training data including the plurality of labels, the item conversion prediction machine-learning model to generate a set of initial values for a set of parameters of the item conversion prediction machine-learning model. The online system 140 may receive (e.g., at the machine-learning training module 230), from the device associated with the user and via the network, feedback data with an indication of whether the user converted on each item of the plurality of items. The online system 140 may re-train the item conversion prediction machine-learning model by updating (e.g., via the machine-learning training module 230), using the feedback data, the set of parameters of the item conversion prediction machine-learning model.

The online system 140 may group (e.g., via the grouping module 260), based at least in part on the metadata for each item of the plurality of items, the plurality of items into a plurality of categories. The online system 140 may access a category conversion prediction machine-learning model of the online system 140 (e.g., via the category ranking module 270), wherein the category conversion prediction machine-learning model is trained to predict a likelihood of the user converting on one or more items in each category of the plurality of categories. The online system 140 may apply the category conversion prediction machine-learning model (e.g., via the category ranking module 270) to the metadata, the information about each item, and the information about the user to generate a category conversion score for each category of the plurality of categories that is indicative of the likelihood of the user converting on the one or more items in each category of the plurality of categories. The online system 140 may rank (e.g., via the category ranking module 270), based on the category conversion score for each category, the plurality of categories to generate a ranked plurality of categories. The online system 140 may generate (e.g., via the content presentation module 210), using the ranked plurality of categories, a second user interface signal including information about a category rearrangement of each category of the plurality of categories. The online system 140 may send (e.g., via the content presentation module 210), via the network, the second user interface signal to the device associated with the user, wherein the sending the second user interface signal causes the device associated with the user to display the user interface with each category of the plurality of categories placed at the user interface in accordance with the category rearrangement.

The online system 140 may apply the item conversion prediction machine-learning model (e.g., via the item ranking module 280) to the metadata for each item of each ranked category of the ranked plurality of categories, information about each item of each ranked category, and the information about the user to generate an item conversion score for each item of each ranked category that is indicative of the likelihood of the user converting on each item of each ranked category. The online system 140 may rank (e.g., via the item ranking module 280), based on the item conversion score for each item of each ranked category, items in each ranked category to generate a ranked set of items for each ranked category. The online system 140 may generate (e.g., via the content presentation module 210), using the ranked plurality of categories and the ranked set of items for each ranked category, a third user interface signal including information about the category rearrangement and an item rearrangement of each item of each ranked category. The online system 140 may send (e.g., via the content presentation module 210), via the network, the third user interface signal to the device associated with the user, wherein the sending the third user interface signal causes the device associated with the user to display the user interface with each category of the plurality of categories placed at the user interface in accordance with the category rearrangement and with each item of each ranked category placed at the user interface in accordance with the item rearrangement.

The online system 140 may retrieve (e.g., via the grouping module 260), from the database, a hierarchical classification of each item of the plurality of items. The online system 140 may group (e.g., via the grouping module 260), further based on the hierarchical classification of each item of the plurality of items, the plurality of items into the plurality of categories. Alternatively, the online system 140 may obtain (e.g., via the grouping module 260) a plurality of embeddings for the plurality of items, each of the plurality of embeddings including an indication of a past classification of each item with other items of the plurality of items. The online system 140 may apply the nearest neighbor algorithm to the plurality of embeddings to group the plurality of items into the plurality of categories.

The online system 140 may generate (e.g., via the machine-learning training module 230) a plurality of labels for training data, each label of the plurality of labels including a first indication of a conversion rate of each category from a collection of categories over a defined time period and a second indication of a ranking feature for each category from the collection of categories. The online system 140 may train (e.g., via the machine-learning training module 230), using the training data including the plurality of labels, the category conversion prediction machine-learning model to generate a set of initial values for a set of parameters of the category conversion prediction machine-learning model. The online system 140 may receive (e.g., at the machine-learning training module 230), from the device associated with the user and via the network, feedback data with an indication of whether the user converted on each category of the plurality of categories. The online system 140 may re-train the category conversion prediction machine-learning model by updating (e.g., via the machine-learning training module 230), using the feedback data, the set of parameters of the category conversion prediction machine-learning model.

Embodiments of the present disclosure are directed to the online system 140 that utilizes trained machine-learning models for personalized ranking of categories of items and items (e.g., items within each category) in a user interface of the online system 140. The online system 140 presented herein ingests items from a printed document (e.g., promotional document or flyer), generates an electronic version of the items, rearranges the items based on a predicted engagement score from a trained machine-learning model, and finally outputs an electronic version of the document with the rearrangement of the items that is personalized for a given user of the online system 140. The online system 140 may collect the items into categories first, rank and arrange the categories, and then rank and arrange the items within each category.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

1. A method, performed at a computer system comprising a processor and a computer-readable medium, comprising:
obtaining an electronic version of a physical document including metadata for each item of a plurality of items in the physical document;
accessing an item conversion prediction model wherein the item conversion prediction model is a machine-learning model trained to predict a likelihood of a user of the computer system converting on each item of the plurality of items;
applying the item conversion prediction model to identities of the plurality of items in the physical document included in the metadata, information about each item of the plurality of items, information about the user including an embedding vector for the user, and information about a set of one or more items added to a current cart of the user to generate an item conversion score for each item of the plurality of items that is indicative of the likelihood of the user converting on each item of the plurality of items, wherein each vector dimension of the embedding vector includes an indication about whether the user converted on a respective item from a corresponding category of items identified in the physical document;
ranking, using the item conversion score for each item, the plurality of items to generate a ranked plurality of items;
generating, using the ranked plurality of items, a first user interface signal including information about a rearrangement of each item of the plurality of items; and
sending, via a network, the first user interface signal to a device associated with the user, wherein sending the first user interface signal causes the device associated with the user to display a user interface with each item of the plurality of items placed at the user interface in accordance with the rearrangement.

2. The method of claim 1, further comprising:
grouping, using the metadata for each item of the plurality of items, the plurality of items into a plurality of categories;
accessing a category conversion prediction model wherein the category conversion prediction machine model is a machine-learning model trained to predict a likelihood of the user converting on one or more items in each category of the plurality of categories;
applying the category conversion prediction model to the metadata, the information about each item, and the information about the user to generate a category conversion score for each category of the plurality of categories that is indicative of the likelihood of the user converting on the one or more items in each category of the plurality of categories;
ranking, using the category conversion score for each category, the plurality of categories to generate a ranked plurality of categories;
generating, using the ranked plurality of categories, a second user interface signal including information about a category rearrangement of each category of the plurality of categories; and
sending, via the network, the second user interface signal to the device associated with the user, wherein sending the second user interface signal causes the device associated with the user to display the user interface with each category of the plurality of categories placed at the user interface in accordance with the category rearrangement.

3. The method of claim 2, further comprising:
applying the item conversion prediction model to the metadata for each item of each ranked category of the ranked plurality of categories, information about each item of each ranked category, and the information about the user to generate an item conversion score for each item of each ranked category that is indicative of the likelihood of the user converting on each item of each ranked category;
ranking, using the item conversion score for each item of each ranked category, items in each ranked category to generate a ranked set of items for each ranked category;
generating, using the ranked plurality of categories and the ranked set of items for each ranked category, a third user interface signal including information about the category rearrangement and an item rearrangement of each item of each ranked category; and
sending, via the network, the third user interface signal to the device associated with the user, wherein sending the third user interface signal causes the device associated with the user to display the user interface with each category of the plurality of categories placed at the user interface in accordance with the category rearrangement and with each item of each ranked category placed at the user interface in accordance with the item rearrangement.

4. The method of claim 2, wherein grouping the plurality of items into the plurality of categories comprises:
retrieving, from a database of the computer system, a hierarchical classification of each item of the plurality of items; and
grouping, further using the hierarchical classification of each item of the plurality of items, the plurality of items into the plurality of categories.

5. The method of claim 2, wherein grouping the plurality of items into the plurality of categories comprises:
obtaining a plurality of embeddings for the plurality of items, each of the plurality of embeddings including an indication of a past classification of each item with other items of the plurality of items; and
applying a nearest neighbor algorithm to the plurality of embeddings to group the plurality of items into the plurality of categories.

6. The method of claim 2, further comprising:
generating a plurality of labels for training data, each label of the plurality of labels including a first indication of a conversion rate of each category from a collection of categories over a defined time period and a second indication of a ranking feature for each category from the collection of categories; and
training, using the training data including the plurality of labels, the category conversion prediction model to generate a set of initial values for a set of parameters of the category conversion prediction model.

7. The method of claim 2, further comprising:
receiving, from the device associated with the user and via the network, feedback data with an indication of whether the user converted on each category of the plurality of categories; and
re-training the category conversion prediction model by updating, using the feedback data, a set of parameters of the category conversion prediction model.

8. The method of claim 1, wherein obtaining the electronic version of the physical document comprises:
applying at least one of an optical character recognition or a computer vision to the physical document to obtain the electronic version of the physical document including the metadata.

9. The method of claim 1, further comprising:
retrieving, from a database of the computer system, the information about the user including at least one of an identifier of the user, information about past conversions conducted by the user, or an embedding for the user, the embedding for the user including indications on whether the user converted on each of the plurality of items.

10. The method of claim 1, wherein applying the item conversion prediction model comprises:
receiving, from the device associated with the user and via the network, information about one or more items the user converted during a current online session; and
applying the item conversion prediction model further to the information about the one or more items the user converted during the current online session to generate the item conversion score for each item of the plurality of items.

11. The method of claim 1, further comprising:
generating a plurality of labels for training data, each label of the plurality of labels including a first indication of a conversion rate of each item from a collection of items over a defined time period and a second indication of a ranking feature for each item from the collection of items; and
training, using the training data including the plurality of labels, the item conversion prediction model to generate a set of initial values for a set of parameters of the item conversion prediction model.

12. The method of claim 1, further comprising:
receiving, from the device associated with the user and via the network, feedback data with an indication of whether the user converted on each item of the plurality of items; and
re-training the item conversion prediction model by updating, using the feedback data, a set of parameters of the item conversion prediction model.

13. A computer program product comprising a non-transitory computer readable storage medium having instructions encoded thereon that, when executed by a processor, cause the processor to perform steps comprising:
obtaining an electronic version of a physical document including metadata for each item of a plurality of items in the physical document;
accessing an item conversion prediction model, wherein the item conversion prediction model is a machine-learning model trained to predict a likelihood of a user of a computer system converting on each item of the plurality of items;
applying the item conversion prediction model to identities of the plurality of items in the physical document included in the metadata, information about each item of the plurality of items, information about the user including an embedding vector for the user, and information about a set of one or more items added to a current cart of the user to generate an item conversion score for each item of the plurality of items that is indicative of the likelihood of the user converting on each item of the plurality of items, wherein each vector dimension of the embedding vector includes an indication about whether the user converted on a respective item from a corresponding category of items identified in the physical document;
ranking, using the item conversion score for each item, the plurality of items to generate a ranked plurality of items;
generating, using the ranked plurality of items, a first user interface signal including information about a rearrangement of each item of the plurality of items; and
sending, via a network, the first user interface signal to a device associated with the user, wherein sending the first user interface signal causes the device associated with the user to display a user interface with each item of the plurality of items placed at the user interface in accordance with the rearrangement.

14. The computer program product of claim 13, wherein the instructions further cause the processor to perform steps comprising:
grouping, using the metadata for each item of the plurality of items, the plurality of items into a plurality of categories;
accessing a category conversion prediction model, wherein the category conversion prediction model is a machine-learning model trained to predict a likelihood of the user converting on one or more items in each category of the plurality of categories;
applying the category conversion prediction model to the metadata, the information about each item, and the information about the user to generate a category conversion score for each category of the plurality of categories that is indicative of the likelihood of the user converting on the one or more items in each category of the plurality of categories;
ranking, using the category conversion score for each category, the plurality of categories to generate a ranked plurality of categories;
generating, using the ranked plurality of categories, a second user interface signal including information about a category rearrangement of each category of the plurality of categories; and
sending, via the network, the second user interface signal to the device associated with the user, wherein sending the second user interface signal causes the device associated with the user to display the user interface with each category of the plurality of categories placed at the user interface in accordance with the category rearrangement.

15. The computer program product of claim 14, wherein the instructions further cause the processor to perform steps comprising:
applying the item conversion prediction model to the metadata for each item of each ranked category of the ranked plurality of categories, information about each item of each ranked category, and the information about the user to generate an item conversion score for each item of each ranked category that is indicative of the likelihood of the user converting on each item of each ranked category;
ranking, using the item conversion score for each item of each ranked category, items in each ranked category to generate a ranked set of items for each ranked category;
generating, using the ranked plurality of categories and the ranked set of items for each ranked category, a third user interface signal including information about the category rearrangement and an item rearrangement of each item of each ranked category; and
sending, via the network, the third user interface signal to the device associated with the user, wherein sending the third user interface signal causes the device associated with the user to display the user interface with each category of the plurality of categories placed at the user interface in accordance with the category rearrangement and with each item of each ranked category placed at the user interface in accordance with the item rearrangement.

16. The computer program product of claim 14, wherein the instructions further cause the processor to perform steps comprising:
obtaining a plurality of embeddings for the plurality of items, each of the plurality of embeddings including an indication of a past classification of each item with other items of the plurality of items; and
applying a nearest neighbor algorithm to the plurality of embeddings to group the plurality of items into the plurality of categories.

17. The computer program product of claim 14, wherein the instructions further cause the processor to perform steps comprising:
generating a plurality of labels for training data, each label of the plurality of labels including a first indication of a conversion rate of each category from a collection of categories over a defined time period and a second indication of a ranking feature for each category from the collection of categories;
training, using the training data including the plurality of labels, the category conversion prediction model to generate a set of initial values for a set of parameters of the category conversion prediction model;
receiving, from the device associated with the user and via the network, feedback data with an indication of whether the user converted on each category of the plurality of categories; and
re-training the category conversion prediction model by updating, using the feedback data, the set of parameters of the category conversion prediction model.

18. The computer program product of claim 13, wherein the instructions further cause the processor to perform steps comprising:
receiving, from the device associated with the user and via the network, information about one or more items the user converted during a current online session; and
applying the item conversion prediction model further to the information about the one or more items the user converted during the current online session to generate the item conversion score for each item of the plurality of items.

19. The computer program product of claim 13, wherein the instructions further cause the processor to perform steps comprising:
generating a plurality of labels for training data, each label of the plurality of labels including a first indication of a conversion rate of each item from a collection of items over a defined time period and a second indication of a ranking feature for each item from the collection of items;
training, using the training data including the plurality of labels, the item conversion prediction model to generate a set of initial values for a set of parameters of the item conversion prediction model;
receiving, from the device associated with the user and via the network, feedback data with an indication of whether the user converted on each item of the plurality of items; and
re-training the item conversion prediction model by updating, using the feedback data, the set of parameters of the item conversion prediction model.

20. A computer system comprising:
a processor; and
a non-transitory computer-readable storage medium having instructions that, when executed by the processor, cause the computer system to perform steps comprising:
obtaining an electronic version of a physical document including metadata for each item of a plurality of items in the physical document;
accessing an item conversion prediction model, wherein the item conversion prediction model is a machine-learning model trained to predict a likelihood of a user of the computer system converting on each item of the plurality of items;
applying the item conversion prediction model to identities of the plurality of items in the physical document included in the metadata, information about each item of the plurality of items, information about the user including an embedding vector for the user, and information about a set of one or more items added to a current cart of the user to generate an item conversion score for each item of the plurality of items that is indicative of the likelihood of the user converting on each item of the plurality of items, wherein each vector dimension of the embedding vector includes an indication about whether the user converted on a respective item from a corresponding category of items identified in the physical document;
ranking, using the item conversion score for each item, the plurality of items to generate a ranked plurality of items;
generating, using the ranked plurality of items, a first user interface signal including information about a rearrangement of each item of the plurality of items; and
sending, via a network, the first user interface signal to a device associated with the user, wherein sending the first user interface signal causes the device associated with the user to display a user interface with each item of the plurality of items placed at the user interface in accordance with the rearrangement.
